(19) United States
(12) Patent Application Publication
(10) Pub. No.: US 2017/0346311 A1
(43) Pub. Date: Nov. 30, 2017

(54) BATTERY-CAPACITOR-TYPE CHARGING AND DISCHARGING SYSTEM

(71) Applicant: Solomon CHANG, Keelung City (TW)

(72) Inventor: Solomon CHANG, Keelung City (TW)

(21) Appl. No.: 15/293,749

(22) Filed: Oct. 14, 2016

(30) Foreign Application Priority Data
May 27, 2016 (CN) 201620505798.X

(51) Int. Cl. H02J 7/00; H02J 7/34

(52) U.S. Cl. CPC H02J 7/0026; H02J 7/0068; H02J 7/345

(57) ABSTRACT

The present invention discloses a battery-capacitor-type charging and discharging system which includes a supply module, a capacitor module and a switcher module. The supply module is a power provider and is connected with the capacitor module parallel. The capacitor module stores the electricity, and an end of the capacitor module is connected with the supply module parallel; whereas, the other end of the capacitor module is connected with an external device. The switcher module is a protector which includes a first conduction end and a second conduction end. The first conduction end is connected between the supply module and the capacitor module, and the second conduction end is connected between the capacitor module and the external device. The supply module provides a voltage which is larger than that of the capacitor module to charge, thereby forming a system which can charge and discharge by itself.

### BACKGROUND OF THE INVENTION

a) Field of the Invention

The present invention relates to a battery-capacitor-type charging and discharging system, and more particularly to a charging and discharging system which is provided with an independent supply module and capacitor module so that the charging can be performed by the system itself to supply sufficient electricity at any time.

b) Description of the Prior Art

The electrical energy device and the power device can bring us a lot of convenience in life and can even facilitate implementation to develop the maximal performance.

However, when the electrical energy device and the power device are activating, the electricity is supplied by a battery device to start up an external device through a start-up system; whereas, the external device, can be a power mechanic apparatus or an electronic product.

Due to the innovation of modern technology, a portable charging device can be also used to supply the electricity to the external device. As shown in FIG. 1, considering the compact design, a conventional charging device 3 is implemented as a lithium battery 30 which is advantageous in light weight, high energy density, and being able to charge and discharge directly. In addition, the lithium battery 30 can be fitted with a boosted circuit to start up the power mechanic apparatus. However, the shortcomings of the lithium battery 30 are that in a place with a large temperature difference or in a winter time with temperature below −10° C., the lithium battery 30 will not function due to the weather condition, and that the lithium battery 30 can be easily overloaded and burnt down as it has not protection device.

Accordingly, the present invention discloses a battery-capacitor-type charging and discharging system which is assembled by a supply module, a capacitor module and a switcher module, providing a user with a system that can charge by itself, is equipped with a charging and discharging protection mechanism and can supply the electricity to the external device for use at any time, without worrying about the weather condition.

### SUMMARY OF THE INVENTION

Accordingly, the primary object of the present invention is to provide a battery-capacitor-type charging and discharging system which can function to charge and discharge under any weather condition.

The technical features of the present invention are that the said capacitor module is provided with plural capacitor elements which are connected serially and parallel to discharge without being affected by the weather condition, and that the charging and recharging system includes a supply module, a capacitor module and a switcher module, with the supply module being a power provider and connected with the capacitor module parallel, the capacitor module storing the electricity, an end of the capacitor module being connected with the supply module parallel, the other end of the capacitor module being connected with an external device, the switcher module being a protector and including a first conduction end and a second conduction end, the first conduction end being connected between the supply module and the capacitor module, the second conduction end being connected between the capacitor module and the external device, and the supply module providing a voltage larger than that of the capacitor module to charge, thereby forming a system which can charge and discharge by itself.

A secondary object of the present invention is to provide a battery-capacitor-type charging and discharging system, wherein the supply module is provided with battery elements which can be rechargeable batteries or non-rechargeable batteries.

Another object of the present invention is to provide a battery-capacitor-type charging and discharging system, wherein the capacitor module is provided with plural capacitor elements which are connected serially and parallel.

Still another object of the present invention is to provide a battery-capacitor-type charging and discharging system, wherein when the supply module is charging to the capacitor module, the first conduction end is in the conducting state, and the second conduction end is in the switch-off state.

Yet still another object of the present invention is to provide a battery-capacitor-type charging and discharging system, wherein when the capacitor module is discharging to the external device, the first conduction end is in the switch-off state, and the second conduction end is in the conducting state.

To enable a further understanding of the said objectives and the technological methods of the invention herein, the brief description of the drawings below is followed by the detailed description of the preferred embodiments.

### BRIEF DESCRIPTION OF THE DRAWINGS

FIG. 1 shows a schematic view of a conventional battery system.

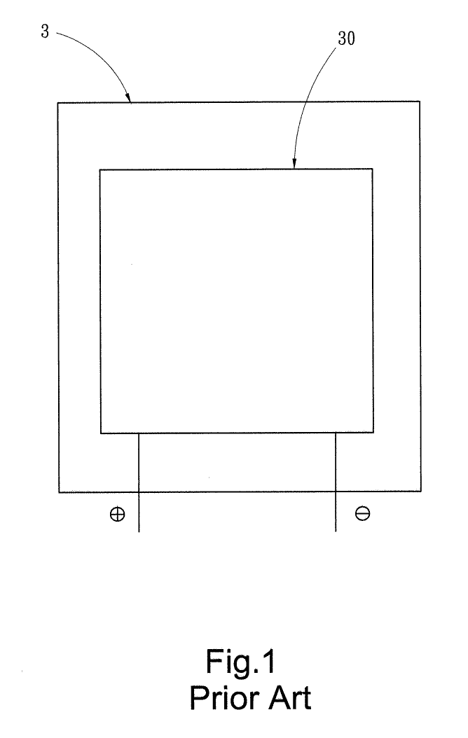

FIG. 2 shows a schematic view of a battery-capacitor-type charging and discharging system, according to the present invention.

FIG. 3 shows a schematic view illustrating that a capacitor module of the battery-capacitor-type charging and discharging system is discharging, according to the present invention.

FIG. 4 shows a schematic view illustrating that a supply module of battery-capacitor-type charging and discharging system is charging, according to the present invention.

### DETAILED DESCRIPTION OF THE PREFERRED EMBODIMENTS

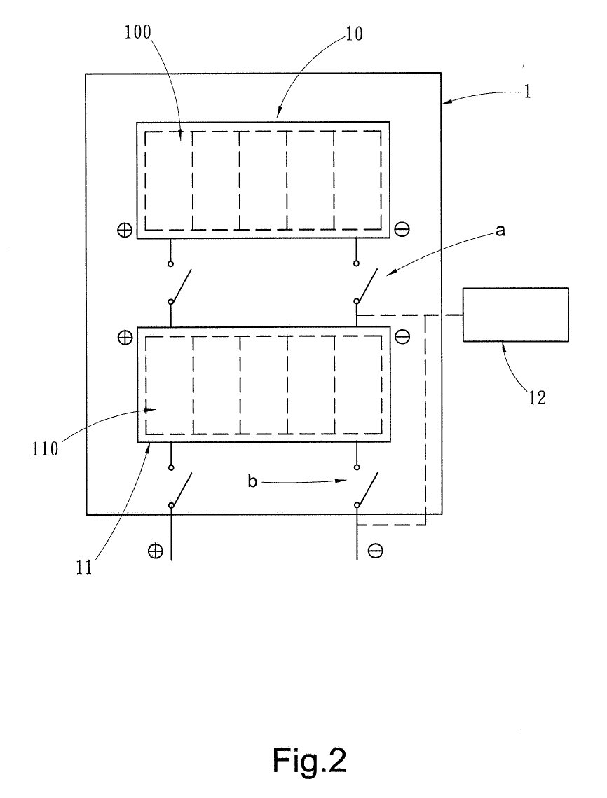

First, referring to FIG. 2, a charging and discharging system 1 comprises a supply module 10, a capacitor module 11 and a switcher module 12. The supply module 10 charges to the capacitor module 11, and the capacitor module 11 discharges to an external device. The switch-off operation or the conducting operation is carried out when the charging operation or the discharging operation is performed through the switcher module 12, thereby forming a charging and discharging system.

The supply module 10 is a power provider and is connected with the capacitor module 11 parallel, wherein the supply module 10 is provided with plural battery elements 100 which can be rechargeable batteries or non-rechargeable batteries. The sum of the voltages of the battery elements 100 is larger than the voltage of the capacitor module 11 to provide a faster charging mechanism.

The capacitor module 11 stores the electricity and is provided with plural capacitor elements 110 which are connected serially and parallel. The capacitor elements 110 are connected with each other serially and parallel, so that the discharging operation can be performed with one end of the capacitor module 11 being connected with an external device 2 (not shown in the drawing), whereas the other end of the capacitor module 11 is connected with the supply module 10.

The switcher module 12 is a protector and is provided with a first conduction end a and a second conduction end b. The first conduction end a is connected between the supply module 10 and the capacitor module 11, and the second conduction end b is connected between the capacitor module 11 and the external device 2. When the supply module 10 is charging to the capacitor module 11, the first conduction end a of the switcher module 12 is switched to the conducting state, and the second conduction end b is switched to the switch-off state. On the other hand, when the capacitor module 11 is discharging to the external device 2, the second conduction end b of the switcher module 12 is switched to the conducting state, and the first conduction end a is switched to the switch-off state. Accordingly, the present invention can form a system which can charge and discharge by itself.

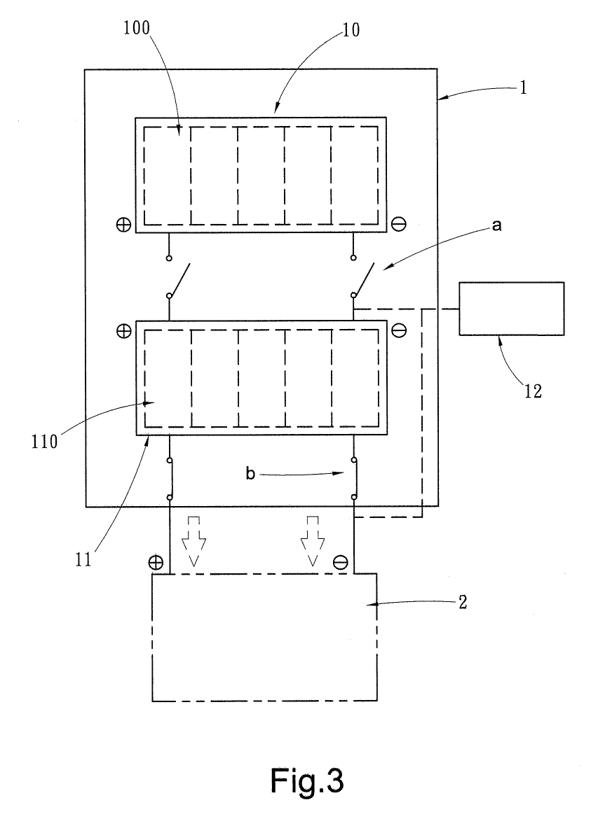

Referring to FIG. 3, it shows a schematic view illustrating that the capacitor module 11 is discharging. The capacitor module 11 is provided with plural capacitor elements 110 which are connected with each other serially and parallel to discharge to the external device 2. When the discharging operation is performed, the second conduction end b of the switcher module 12 is in the conducting state, and the first conduction end a is in the switch-off state.

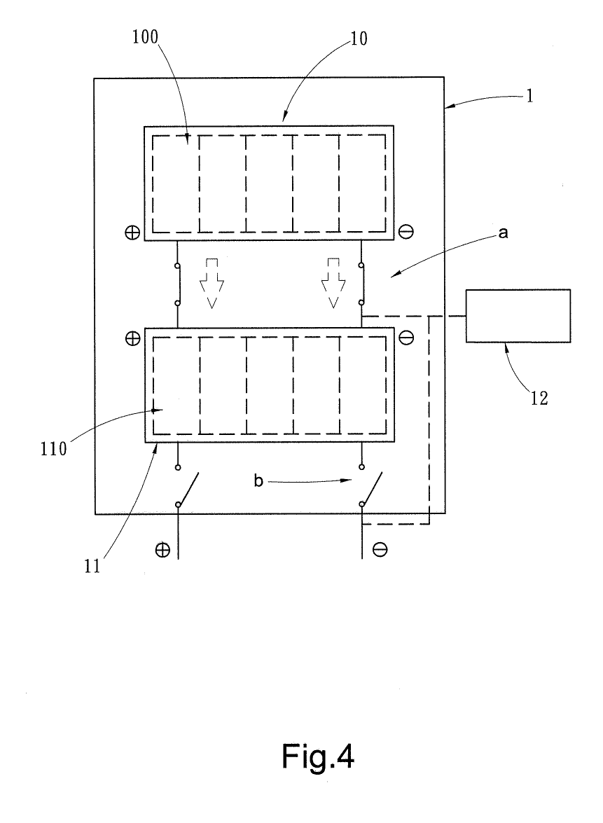

Referring to FIG. 4, it shows a schematic view illustrating that the supply module 10 is charging. The supply module 10 is provided with plural battery elements 100 which are connected serially and parallel. The battery elements 100 can be rechargeable batteries or non-rechargeable batteries, and the sum of the voltages of the battery elements 100 is larger than the voltage of the capacitor module 11. When the supply module 10 is charging to the capacitor module 11, the first conduction end a of the switcher module 12 is switched to the conducting state, and the second conduction end b is in the switch-off state. Accordingly, whether the charging operation or the discharging operation is performed, the conducting operation or the switch-off operation is controlled by the switcher module 12, so as to provide better protection to the charged end and the discharged end.

It is of course to be understood that the embodiments described herein is merely illustrative of the principles of the invention and that a wide variety of modifications thereto may be effected by persons skilled in the art without departing from the spirit and scope of the invention as set forth in the following claims.

What is claimed is:

1. A battery-capacitor-type charging and discharging system comprising a supply module, a capacitor module and a switcher module, wherein the supply module is connected with the capacitor module parallel and provides electricity to the capacitor module, an end of the capacitor module is connected with the supply module parallel, another end of the capacitor module is connected with an external device, the capacitor module stores the electricity, the switcher module is provided with a first conduction end and a second conduction end, the first conduction end is connected between the supply module and the capacitor module, the second conduction end is connected between the capacitor module and the external device, the switcher module is a charging and discharging protector to the supply module and the capacitor module, and the supply module provides a voltage larger than that of the capacitor module to charge, thereby forming a system which charges and discharges by itself.

2. The battery-capacitor-type charging and discharging system according to claim 1, wherein the supply module is provided with battery elements which are implemented as rechargeable batteries or non-rechargeable batteries.

3. The battery-capacitor-type charging and discharging system according to claim 1, wherein the capacitor module is provided with plural capacitor elements which are connected serially or parallel.

4. The battery-capacitor-type charging and discharging system according to claim 1, wherein when the supply module is charging to the capacitor module, the first conduction end is in conducting state and the second conduction end is in switch-off state.

5. The battery-capacitor-type charging and discharging system according to claim 1, wherein when the capacitor module is discharging to an external device, the first conduction end is in switch-off state and the second conduction end is in conducting state.
